(19) United States
(12) Patent Application Publication
(10) Pub. No.: US 2003/0223093 A1
(43) Pub. Date: Dec. 4, 2003

(54) User-personalized print menus

(76) Inventors: Jeffrey C. Baird, Meridian, ID (US); Brandon R. Ashey, Boise, ID (US); Michael P. Prenn, Star, ID (US)

Correspondence Address: HEWLETT-PACKARD COMPANY, Intellectual Property Administration, P.O. Box 272400, Fort Collins, CO, 80527-2400, US

(21) Appl. No.: 10/162,815

(22) Filed: Jun. 3, 2002

(51) Int. Cl. G06K 1/00

(52) U.S. Cl. 358/1.15

(57) ABSTRACT

With user-personalized print menus, user log in information is received at a local input component of a printing device. A personalized print menu based on the user log in information is retrieved and presented at the printing device. According to another aspect, print menu personalization options are presented to a user. User-selection of one or more of the menu personalization options is received, and a personalized menu based at least in part on the received user-selection is generated and associated with the user.

### TECHNICAL FIELD

This invention relates generally to printing devices, and more particularly to user-personalized print menus.

### BACKGROUND

As computer technology has advanced, so too has the technology of peripheral devices used by computers, such as printers which allow users to generate hard copies (e.g., paper copies) of documents supplied to the printer by a computer. These advances have resulted in printers becoming increasingly commonplace in homes, businesses, and elsewhere throughout the world.

Many printers currently available have print menus that allow users to set various default print parameters such as duplex/simplex printing, number of copies, print quality, etc. These default print parameters are used by the printer to print documents (and optionally may be overridden on a per-print job basis). These printers also typically have interfaces, such as keypads and displays, that allow a user to interact with the printer's print menu. For example, the menu can be displayed on the printer's display and the user can maneuver through the various menu items and set them as he or she desires using the printer's keypad. The parameters set in the print menu typically remain set for subsequent print jobs until they are changed by the user (or alternatively some other user).

One problem encountered with these print menus, however, is that they frequently change from one printer model to the next. As new printer models are being continually developed and sold, this results in a large number of different printers, and thus print menus, that the users of the printers must learn. Thus, it would be beneficial to provide a way to improve the ease of use and consistency of print menus.

The user-personalized print menus described herein help solve these problems.

### SUMMARY

User-personalized print menus are described herein.

According to one aspect, user log in information is received at a local input component of a printing device. A personalized print menu based on the user log in information is retrieved and presented at the printing device.

According to another aspect, print menu personalization options are presented to a user. User-selection of one or more of the menu personalization options is received, and a personalized menu based at least in part on the received user-selection is generated and associated with the user.

### BRIEF DESCRIPTION OF THE DRAWINGS

FIG. 1 illustrates an exemplary environment in which the user-personalized print menus can be employed.

FIG. 2 is a block diagram illustrating an exemplary printing device in additional detail.

FIG. 3 is a flowchart illustrating an exemplary process for using personalized print menus.

FIG. 4 is a flowchart illustrating an exemplary process for personalizing print menus.

FIG. 5 illustrates an exemplary print menu personalization display.

FIGS. 6, 7, 8, and 9 illustrate exemplary selecting and rearranging of print menu items.

FIG. 10 illustrates portions of an exemplary device in additional detail.

### DETAILED DESCRIPTION

User-personalized print menus are described herein. Each user of a printer is able to personalize or customize the print menu of the printer to his or her liking and have that personalized/customized print menu stored for later use. When the user subsequently identifies himself or herself to the printer (e.g., the user may log in to the printer with a user ID), the print menu personalized/customized by the user is retrieved and presented to the user.

Print menus allow various printing and printer parameters to be set by a user locally at the printer (e.g., via a keypad on the printer). A wide variety of printing parameters can be set, such as number of copies, print quality, paper orientation, duplex printing on/off, and so on. A wide variety of printer parameters can also be set, such as a period of inactivity before the printer should go into a power save mode, whether the printer should continue printing when the toner is low, whether to print an event log, whether to perform various print tests, and so forth. Numerous printing and printer parameters are well-known to those skilled in the art, any of which can be used with the user-personalized print menus described herein.

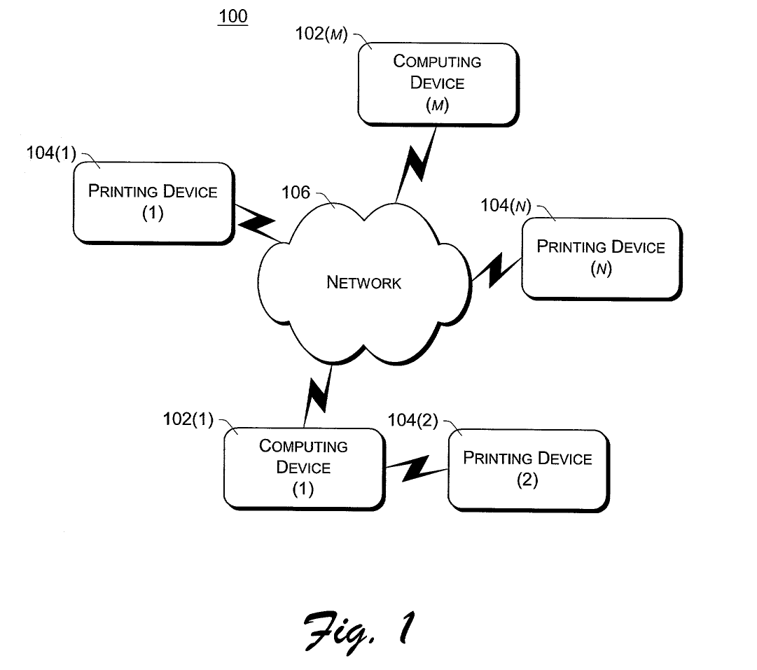

FIG. 1 illustrates an exemplary environment 100 in which the user-personalized print menus can be employed. In environment 100, multiple (m) computing devices 102 are coupled to one or more of multiple (n) printing devices 104 via a network 106 and/or directly. Network 106 is intended to represent any of a wide variety of conventional network topologies and types (including wired and/or wireless networks), employing any of a wide variety of conventional network protocols (including public and/or proprietary protocols).

Computing devices 102 can be any of a wide variety of conventional computing devices, including desktop PCs, workstations, server computers, Internet appliances, gaming consoles, handheld PCs, cellular telephones, personal digital assistants (PDAs), etc. Computing devices 102 can be the same types of devices, or alternatively different types of devices.

Printing devices 104 can be any of a wide variety of conventional devices capable of generating a hard copy of data (e.g., received from one of computing devices 102). Examples of printing devices include printers, facsimile machines, multi-function machines (e.g., capable of performing multiple functions, such as the functions of both a printer and a facsimile machine). Printing devices 104 can generate hard copies of data in any of a variety of manners, such as by using toner (e.g., in laser printers), ink (e.g., in inkjet printers, bubblejet printers, dot matrix printers, etc.), heat applied to heat-sensitive print media (e.g., thermal printers), and so forth. Printing devices 104 can be the same types of devices, or alternatively different types of devices.

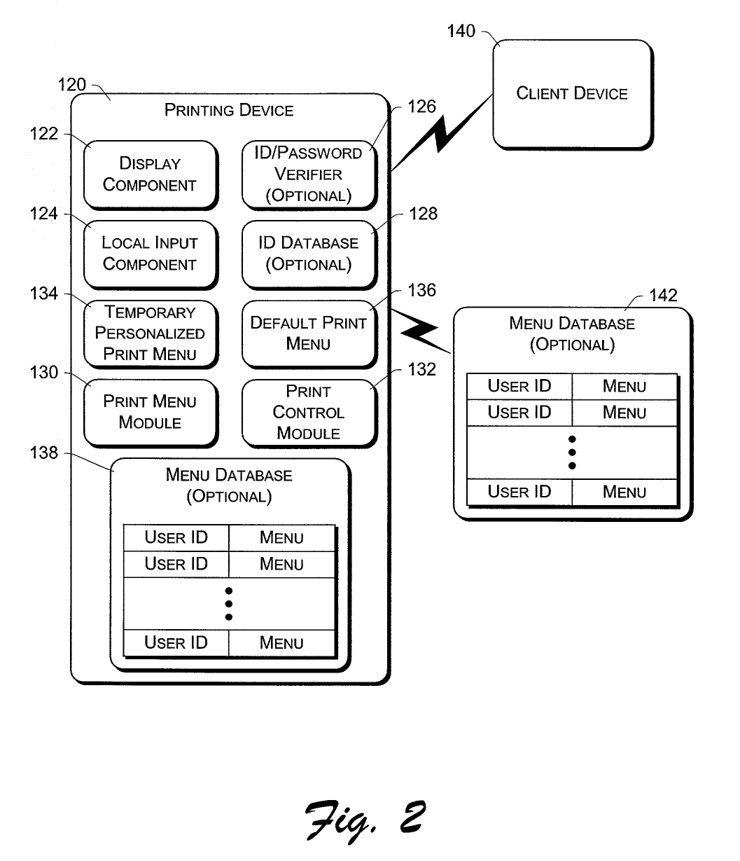

FIG. 2 is a block diagram illustrating an exemplary printing device 120 in additional detail. Printing device 120 can be any of printing devices 104 of FIG. 1. Printing device 120 includes several modules or components: display component 122, local input component 124, optional ID/password verifier 126, optional ID database 128, print menu module 130, print control module 132, temporary personalized print menu 134, default print menu 136, and an optional menu database 138. The components in FIG. 2 are exemplary only; the exact components included in any particular computing device can vary based on the type of device.

Display component 122 allows print menu items and other information to be presented to a user of printing device 120 locally. Display component 122 may include one or more of a display screen (e.g., an LED or LCD display), a speaker, a tactile feedback device to present Braille, etc. Local input component 124 allows users to input information to printing device 120 locally. Local input component 124 may include, for example, one or more buttons or keys, cursor control devices (e.g., a trackball, trackpad, directional keys, etc.), a touchscreen, etc. Components 122 and 124 may also include software, firmware, and/or hardware modules to allow management and control of the corresponding hardware components (e.g., display screen, keypad, etc.). Components 122 and 124 allow a local user of device 120 (e.g., a user standing at device 120 rather than accessing device 120 via a network) to interact with device 120.

Optional ID/password verifier 126 operates to verify user ID and password combinations. In one implementation, a user's personalized print menu is tied to his or her user ID and password. In order for the user to access his or her personalized print menu, he or she must log in to printing device 120. The user is prompted for his or her user ID and password via display component 122, and inputs his or her user ID and password via local input component 124. Verifier 126 then checks whether the password matches the user ID (that is, whether the password entered by the user is the password associated with the user ID), and if so, allows the personalized print menu associated with the user ID to be presented to the user via display component 122. However, if the password does not match the user ID, then verifier 126 does not allow the personalized print menu associated with the user ID to be presented to the user (e.g., the user ID is not passed to print menu module 130, discussed below).

Verifier 126 can manage the user ID and corresponding passwords of users in an optional ID database 128, in which case the user establishes a user ID and password combination specific to printing device 120. This may be performed by the user as a separate registration process (e.g., managed by verifier 126) performed locally and/or remotely, or alternatively as part of the print menu personalization process discussed in more detail below. In this situation, ID database 128 stores associations (e.g., mappings) of user IDs to passwords. ID database 128 may store the associations in encrypted from, or alternatively use other mechanisms to secure the associations and prevent unauthorized access.

Alternatively, verifier 126 may not manage user ID and password combinations, but rather pass the user ID and password to a central authority on the network (e.g., network 106 of FIG. 1) for verification. For example, network 106 may include a central server (or other computing device) that is responsible for controlling the logging in of users to the network (or to another computing device). In this example, verifier 126 communicates the received user ID and password to this central server (or other computing device) along with a request for an indication of whether the User ID and password match. Verifier 126 receives an indication from the central server (or other computing device) of whether the user ID and password matched.

In some implementations a user's personalized print menu is tied to a user ID but not to a password. In these implementations, verification of a user ID and password combination is not necessary, so ID/password verifier 126 need not be included in device 120.

Print control module 132 manages the printing of data by device 120 in a conventional manner in order to generate a hard copy. Print requests can be received from a computing device 140 via a network (e.g., network 106 of FIG. 1) and/or directly via from computing device 140.

Print menu module 130 manages the creation, storage, and retrieval of personalized or customized print menus. When a user of device 120 enters his or her user ID via local input component 124, the user ID is passed to print menu module 130 (after being verified, if necessary). Print menu module 130 accesses a menu database which maintains mappings of user IDs to personalized print menus and retrieves the appropriate personalized print menu for the user ID. This print menu is then used by printing device 120 as temporary personalized print menu 134 for as long as the user is logged in. Personalized print menu 134 is referred to as temporary because it is the current print menu to be used by printing device 120 (e.g., displayed to the user via display component 122) for as long as the user is logged in. Once the user logs out, that print menu is no longer used (unless the user logs back in).

The menu database may be stored on a local storage component (e.g., a hard drive or other mass storage device or nonvolatile memory) at printing device 120 (database 138), remotely on one or more devices external to printing device 120 (database 142), or combinations thereof. Menu databases 138 and 142 include mappings of user IDs to personalized menus, allowing individual personalized menus to be stored on a per-user ID basis. Databases 138 and 142 may include the actual personalized menus, or alternatively references to where the personalized menus can be found (e.g., a uniform resource locator (URL) or other pointer/identifier). The personalized menus themselves can thus be stored elsewhere and only a reference to the menus stored in database 138 or 142, thereby reducing the storage space requirements of the database 138 or 142.

Printing device 120 also includes a default print menu 136, which is used by printing device 120 as the print menu in situations where there is no personalized print menu. For example, the menu database may not have a mapping for a particular user ID, in which case default print menu 136 is used by device 120. By way of another example, a user may not log in to printing device 120 but still want to access the print menu, in which case default print menu 136 is used by device 120.

Each print menu item typically has two or more settings. For example, a “printing-orientation” item may have two settings (“landscape” and “portrait”), while a “printing-copies” item may have 99 settings (the values 1 through 99). The menu items and corresponding possible settings of the personalized print menu can be stored in a variety of different manners. For example, a new data structure may be generated for the personalized print menu that identifies the ordering of the menu items, their names or labels (e.g., “printing-copies”), their possible settings, and a memory address to begin executing instructions at (or function to invoke) in order to implement the particular menu item. Alternatively, a new data structure may be generated for the personalized print menu that references menu items in default print menu 136 and an order for those items. For example, the data structure may simply include a pointer to (e.g., memory address of) the “printing-copies” menu item in default print menu 136 and an indication of where the menu item is to be displayed in the print menu display.

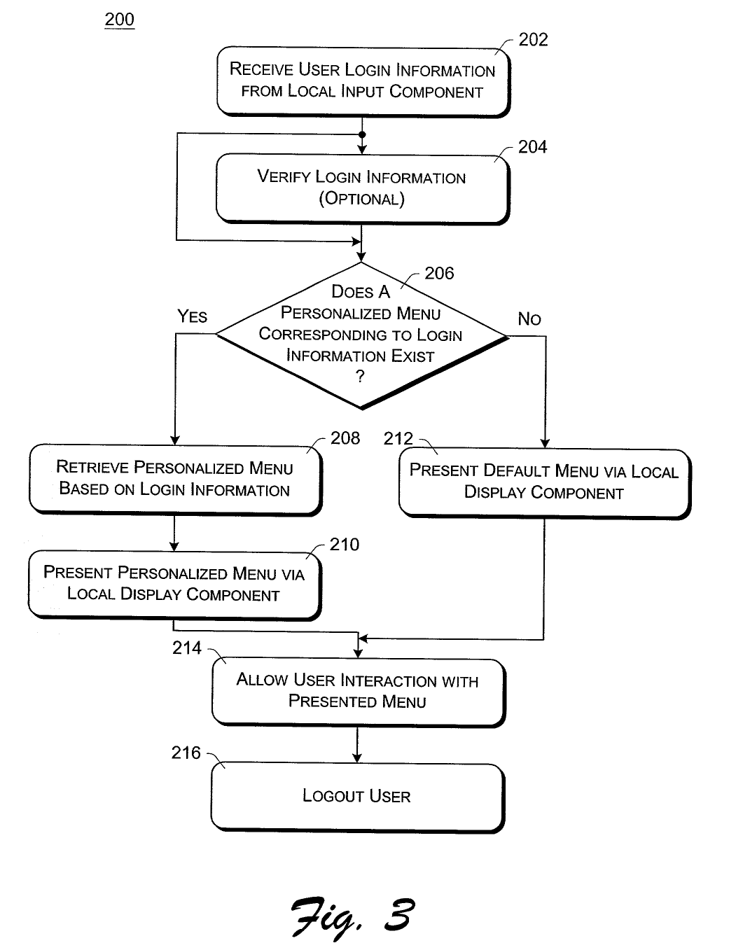

FIG. 3 is a flowchart illustrating an exemplary process 200 for using personalized print menus. Process 200 is performed by a printing device (e.g., printing device 120 of FIG. 2), and may be performed in software, firmware, hardware, or combinations thereof.

Initially, user log in information is received from a local input component (act 202). This user log in information may be a user ID or combination of user ID and password. Optionally, the log in information may be verified, such as by verifier 126 of FIG. 2 (act 204). If verification of the log in information fails, then the process stops. However, if verification of the log in information succeeds, or no verification is performed, then a check is made as to whether a personalized menu corresponding to the log in information exists (act 206). This checking can be made, for example, by accessing a menu database and determining whether any personalized menu is mapped to the user ID.

If a personalized menu exists for the user ID, then the personalized menu is retrieved for the user ID (act 208) and presented to the user via the local display component of the printing device (act 210). However, if no personalized menu exists for the user ID, then a default menu is presented via the local display component of the printing device (act 212). The user is then able to interact with the presented menu (act 214), setting or reviewing whatever printer or printing parameters he or she desires.

Eventually, the user is logged out (act 216). The user may log out himself or herself (e.g., via a “log out” option or button), or alternatively may be logged out by the printing device. For example, the printing device may log a user out if no print jobs have been received at the printing device for at least a threshold amount of time since the user logged in, if there has been no interaction with the print menu for at least a threshold amount of time since the user logged in, etc. Once logged out, the printing device no longer uses the personalized print menu retrieved in act 208, unless the user logs in again.

It should be noted that process 200 is exemplary only—various modifications may be made to process 200. By way of example, if a user logging in to the printing device was also the most recent user to log in and log out of the printing device, then the personalized print menu corresponding to the user may still be maintained in the printing device (e.g., as temporary personalized print menu 134 of FIG. 2). In this situation, the personalized menu may optionally not be retrieved in act 208 as it is already present in the printing device.

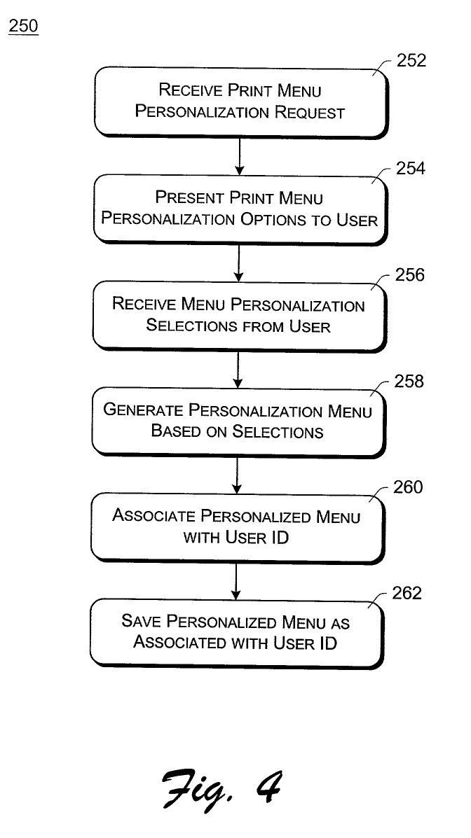

FIG. 4 is a flowchart illustrating an exemplary process 250 for personalizing print menus. Process 250 may be performed by a printing device, a client computing device, or combinations thereof as discussed in more detail below. Process 250 may be performed in software, firmware, hardware, or combinations thereof. Process 250 is for personalizing print menus (e.g., the order of items in a menu, which items are in a menu, etc.), not for setting the printer or printing parameters.

Initially, a request to personalize a print menu is received (act 252). The print menu to be personalized may be the default print menu for the printing device, or alternatively a menu previously personalized by the user. If the user has previously personalized a print menu (e.g., a menu currently stored in a menu database) for the printing device, then the user is given the option of modifying that previous menu or using the default menu. The print menu personalization options are then presented to the user (act 254), and user-selection of one or more menu personalization options are received (act 256). The menu personalization options may take a variety of different forms.

In one implementation, the menu personalization options include multiple previously defined menus (e.g., defined by the manufacturer of the printing device) from which the user can select, such as menus associated with particular printer models. For example, the user may have a new printer model but be familiar with the menu structure of his or her previous printer model. The user can select, from the multiple previously defined menus, the menu associated with his or her previous printer model. The user is thus able to define, for his or her new printer, a personalized print menu that is the same (or approximately the same) as the print menu of his or her previous printer.

FIG. 5 illustrates an exemplary print menu personalization display 270 that lists several printer models. The user is able to select one of these listed printer models and have his or her personalized print menu be the same as the print menu in the selected printer model.

Alternatively, the menu personalization options may include individual menu items corresponding to individual printer and printing parameters, and the user be allowed to select and rearrange these menu items. The selection can take any of a wide variety of forms, such as hi-lighting a menu item with directional keys, using a cursor control device to maneuver an on-screen pointer and “click” on the menu item, having a number associated with each item and having the user input the number associated with the desired item via a keypad, etc. The rearrangement can similarly take any of a wide variety of forms, such as dragging and dropping menu items on a graphical user interface, inputting of numbers associated with the items (with characters such as periods, colons, dashes, etc. being used to represent item and sub-item relationships). Such item-level control allows the user to manipulate menu items into whatever order he or she desires, including numerous levels with items being sub-items of other items. The item-level control also allows the user to select only those menu items that he or she desires to be included in his or her personalized print menu. For example, the user may desire only two menu items in his or her print menu—the number of copies and duplex on/off. The user can thus select only these two options for his or her print menu.

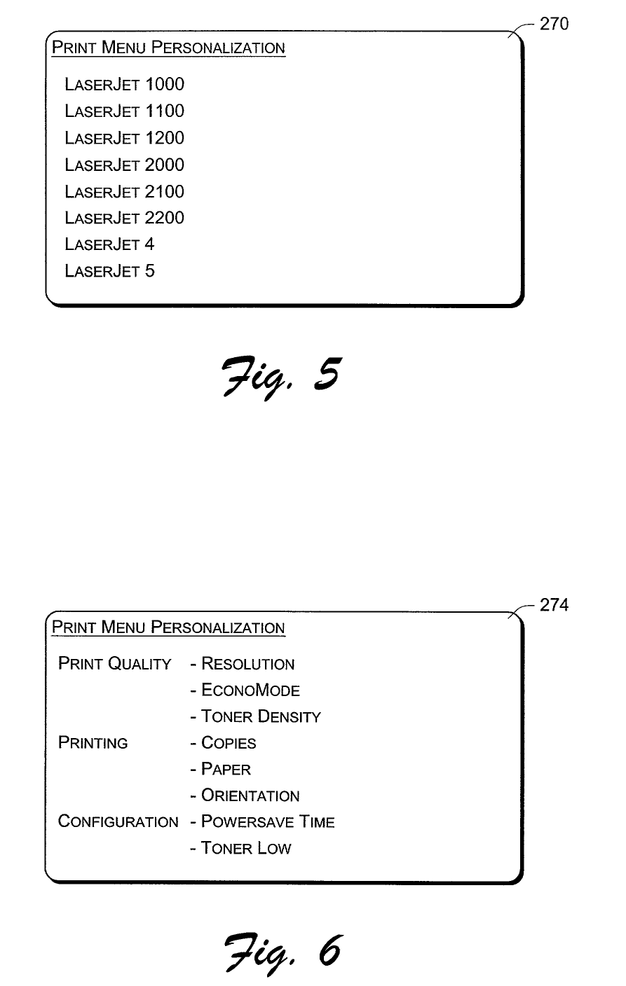

FIGS. 6-9 illustrate exemplary selecting and rearranging of print menu items. FIG. 6 illustrates an exemplary print menu personalization display 274 having several menu items including sub-items. Although print menus typically have additional menu items, these additional items have not been shown so as not to clutter the drawings. Additionally, other items (not shown) that are not currently part of the print menu but that could be added to the print menu may also be displayed on display 274. A first level or “root” level of menu items is shown (the “print quality”, “printing”, and “configuration” items), as well as multiple sub-items (e.g., “resolution”, “economode”, etc.). The menu in display 274 is a default (or previously personalized) print menu. Display 274 (as well as displays 276, 280, and 282 below) identifies an ordering and item/sub-item relationship of print menu items, but does not necessarily show the exact format in which print menu items will be subsequently presented to the user at the printing device (rather, the exact format will depend on the type of display component used in the printing device).

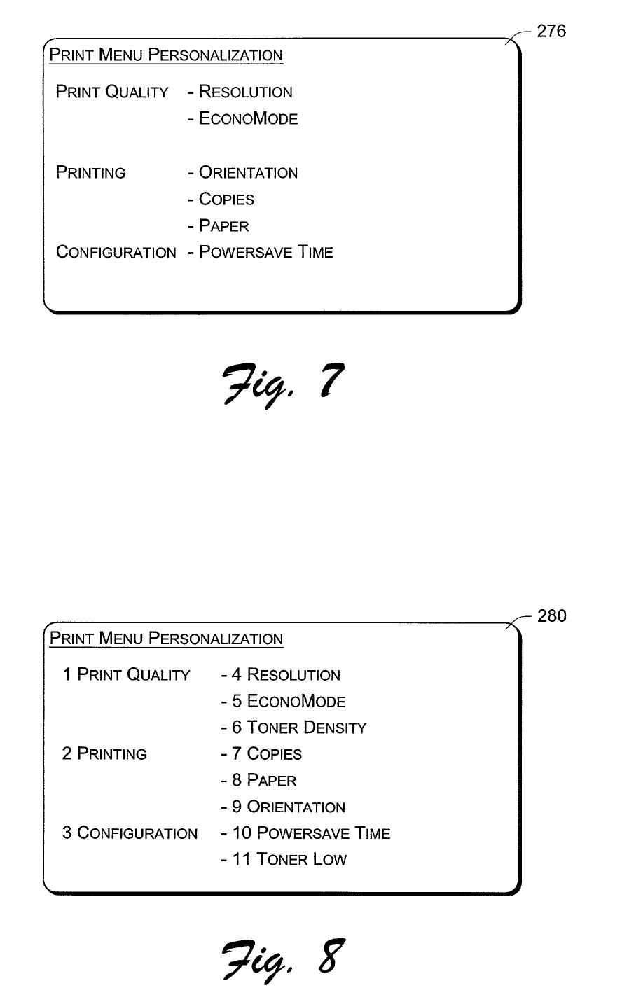

Assume that the user chooses to not select the “toner density” sub-item or the “toner low” sub-item, and that the user further chooses to rearrange the ordering of sub-items so that under the “printing” item the sub-items are in the order “orientation”, then “copies”, then “paper”. FIG. 7 illustrates the resultant print menu personalization display 276.

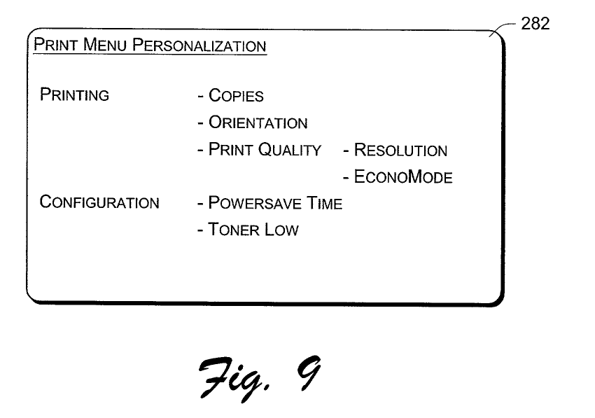

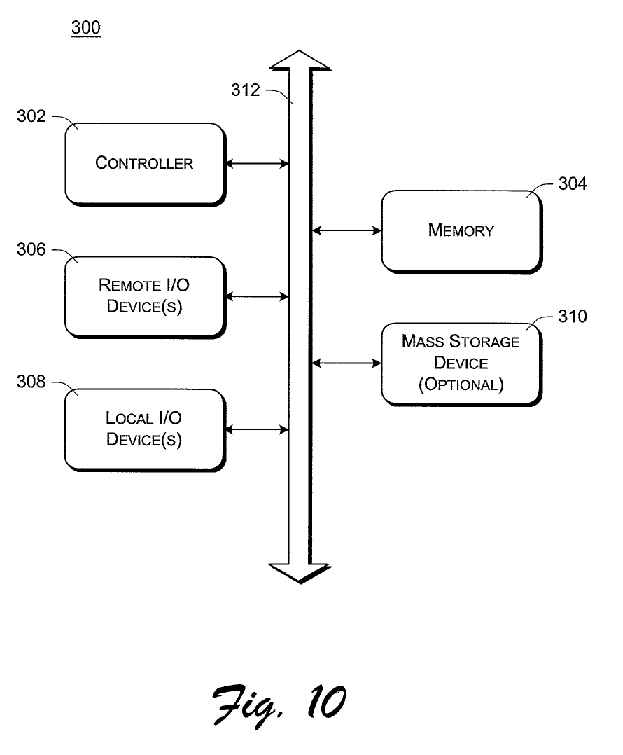

FIG. 8 illustrates another exemplary print menu personalization display 280. Display 280 is similar to display 274 of FIG. 6, except that each menu item has a number associated therewith. Assume that a colon is used to indicate the relationship of menu item to menu sub-item (e.g., “1:6” indicates item 6 is a sub-item of item 1), and that a hyphen is used to indicate new menu items. The user could then enter the sequence “2-2:7-2:9-2:1-2:1:4-2:1:5-3-3:10-3:11” to obtain the print menu illustrated in display 282 of FIG. 9.

A personalized menu for the user is then generated (as necessary) based on the user selections (act 258). If the user has selected a pre-defined menu, then the new menu has already been generated. The personalized menu is associated with a user ID of the user (act 260), and saved as associated with (e.g., mapped to) the user ID (act 262). The user ID to be associated with the user can be input by the user as part of process 250. For example, the user may be required to input his or her user ID in order to begin process 250, or may be prompted for his or her user ID during process 250 (e.g., as part of act 256 or 260). Alternatively, the user ID to be associated with the user may be determined automatically. For example, if process 250 is implemented on a computing device, the user ID of the user logged into the computing device may be obtained by process 250 (e.g., by querying the operating system of the computing device or network server).

Personalization process 250 may be implemented in a variety of different manners. In one implementation, process 250 is implemented on a printing device with the user inputting selections via the local input component of the printing device. In another implementation, process 250 is implemented on a client computing device at any of a variety of different times. For example, when the user is installing a printer driver for a new printing device on a client computing device, the user may be prompted, as part of the installation process, whether he or she would like to generate a personalized print menu. If the user chooses to generate such a personalized print menu, process 250 executes on the client computing device.

In yet another implementation, process 250 is implemented on a combination of a printing device and a client computing device. In this imnplementation, the client computing device can access the printing device (e.g., by its IP address or other identifier). The printing device includes a web server (e.g., implementing the HyperText Transfer Protocol (HTTP)) and one or more web pages (e.g., HyperText Markup Language (HTML) pages) that can be accessed by the client computing device. The web pages include an option (e.g., a button, menu item, etc.) that, when selected, initiates the print menu personalization process 250. The process 250 is then executed by the printing device, with one or more web pages being communicated to the client computing device in order to obtain user selections. For example, a web page may include a script (e.g., written in JavaScript, VBScript (Visual Basic Script), etc.) that is executed at the client computing device allowing the user to select and/or rearrange various menu items. Once completed (e.g., the user selects a “finished” button,, menu option, etc.), the information collected by the script is returned to the printing device and the printing device generates the personalized print menu.

Various modifications to the personalization process 250 may also be made. For example, it may be desirable to restrict the user's ability to personalize print menus to some extent, such as to prevent certain menu items from being removed from the print menu. In this situation, attempts by the user to remove (or simply not select) certain menu items are ignored and those menu items are automatically selected.

By way of another example, situations can arise where the user selects to personalize his or her print menu for a new model printer to be the same as a particular prior printer model, but there may be additional print menu items for the new model printer that did not exist for the prior printer model. In this situation, process 250 prompts the user to indicate how he or she would like to handle these additional print menu items (e.g., include them at the bottom of the print menu, not include any of them, display them to the user as part of process 250 and let the user select which he or she would like to include in his or her personalized print menu, etc.), or alternatively may automatically add them to the print menu (e.g., at the bottom) or drop them (not include them in the personalized print menu).

By way of yet another example, process 250 may allow a user to simply select which menu items he or she would like included in his or her personalized print menu, but not indicate any order. For example, all of the possible print menu items may be displayed with a check box associated with each allowing the user to check those menu items that he or she desires in his or her personalized print menu. The ordering of the print menu items is then left up to process 250 to determine (e.g., the selected print menu items may be arranged in the same order as they appear in the default print menu, may be

arranged randomly or alphabetically, etc.) FIG. 10 illustrates portions of an exemplary device 300 in additional detail. Device 300 can be, for example, a computing device 102 or printing device 104 of FIG. 1, or printing device 120 of FIG. 2. Device 300 includes a processor or controller 302, a memory 304, a remote I/O device(s) 306, a local I/O device(s) 308, and an optional mass storage device 310, all coupled to a bus 312. Depending on the type of the device, various additional conventional components may also be typically included in device 300 (e.g., a printing device will typically include a print engine, print media inputs and outputs, etc.).

Controller or processor 302 can be a general purpose microprocessor or a dedicated microcontroller (e.g., one or more Application Specific Integrated Circuits (ASICs) or programmable logic devices (PLDs)). Remote I/O device(s) 306 is one or more conventional interface devices allowing components of device 300 (e.g., controller 302) to communicate with other devices external to device 300. Remote I/O device(s) 306 may include, for example, a modem, a network interface card (NIC), a parallel port, a serial port, a universal serial bus (USB) port, and so forth. Local I/O device(s) 308 is an interface device allowing local commands and/or data to be input to and/or output from device 300. Local I/O device(s) 308 may include, for example, a display device (e.g., liquid crystal display (LCD), light emitting diode (LED), etc.), a keypad (e.g., alphanumeric or otherwise), a touchscreen, a cursor control device (e.g., a trackpad, trackball, etc.), print media handlers and printing components (e.g., ink or toner dispensers), and so forth.

Bus 312 represents one or more buses in printing device 300, which may be implemented in accordance with public and/or proprietary protocols. The bus architecture can vary by printing device as well as by manufacturer. Mass storage device 310 is optional and represents any of a wide variety of conventional storage devices, such as fixed or removable magnetic or optical disks, Flash memory, etc.

Memory 304 represents volatile and/or nonvolatile memory used to store instructions and data for use by controller or processor 302. Typically, instructions are stored on a mass storage device 310 (or nonvolatile memory portion of memory 304) and loaded into a volatile memory portion of memory 304 for execution by controller or processor 302. Additional memory components may also be involved, such as cache memories internal or external to controller or processor 302. Various embodiments of the invention may be implemented, at different times, in any of a variety of computer readable media that is part of, or readable by, device 300. For example, such computer readable media may be mass storage device 310, memory 304, a cache memory, media (e.g., a magnetic or optical disk) accessible to device 300, and so forth.

Device 300 is exemplary only. It is to be appreciated that additional components (not shown) can be included in device 300 and some components illustrated in device 300 need not be included. For example, additional processors or storage devices, additional I/O interfaces, and so forth may be included in device 300, or mass storage device 310 may not be included.

Various discussions herein refer to components and modules that can be implemented in a printing device or computing device. It is to be appreciated that the components and processes described herein can be implemented in software, firmware, hardware, or combinations thereof. By way of example, a programmable logic device (PLD) or application specific integrated circuit (ASIC) could be configured or designed to implement various components and/or processes discussed herein.

Additionally, the discussions above discuss print menus and print menu items. It is to be appreciated that these print menus and print menu items may include additional device-related parameters which vary based on the nature of the device. For example, a multi-function machine may include scanning or faxing capabilities, and the personalized print menus may include items related to scanning and/or faxing parameters in addition to the printing and printer parameters.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving, at a local input component of a printing device, user log in information;
retrieving a personalized print menu based on the user log in information; and
presenting the personalized print menu at the printing device.

2. A method as recited in claim 1, wherein presenting the personalized print menu comprises displaying the personalized print menu on a local display component of the printing device.

3. A method as recited in claim 1, wherein the user log in information comprises a user ID.

4. A method as recited in claim 1, wherein the user log in information comprises a user ID and password, and further comprising:
checking whether the user ID and password match; and
retrieving the personalized print menu and presenting the personalized print menu only if the user ID and password match.

5. A method as recited in claim 1, wherein the retrieving comprises:
checking whether at least part of the user log in information corresponds to a personalized print menu; and
retrieving the personalized print menu and presenting the personalized print menu if at least part of the user log in information corresponds to the personalized print menu, otherwise retrieving a default print menu and presenting the default print menu at the printing device.

6. A method as recited in claim 1, wherein retrieving the personalized print menu comprises retrieving the personalized print menu from a remote device.

7. A method as recited in claim 1, wherein retrieving the personalized print menu comprises retrieving the personalized print menu from a local storage component of the printing device.

8. One or more computer readable media having stored thereon a plurality of instructions that, when executed by one or more controllers of a printing device, causes the one or more controllers to:
receive, at a local input component of the printing device, user log in information;
retrieve a personalized print menu based on the user log in information; and
present the personalized print menu at the printing device.

9. One or more computer readable media as recited in claim 8, wherein the user log in information comprises a user ID and password, and wherein the plurality of instructions further cause the one or more controllers to:
check whether the user ID and password match; and
retrieve the personalized print menu and present the personalized print menu only if the user ID and password match.

10. One or more computer readable media as recited in claim 8, wherein the plurality of instructions that cause the one or more controllers to retrieve the personalized menu comprise instructions that cause the one or more controllers to:
check whether at least part of the user log in information corresponds to a personalized print menu; and
retrieve the personalized print menu and present the personalized print menu if at least part of the user log in information corresponds to the personalized print menu, and otherwise retrieve a default print menu and present the default print menu at the printing device.

11. A printing device comprising:
a local input component to receive user log in information;
a print menu module, coupled to receive the user log in information from the local input component, configured to retrieve a personalized print menu based on the user log in information; and
a local display component to present, at the printing device, the retrieved personalized print menu.

12. A printing device as recited in claim 11, wherein the user log in information comprises a user ID and password, and wherein the printing device further comprises:
a verifier to check whether the user ID and password match, and permit the print menu module to retrieve the personalized print menu and present the personalized print menu only if the user ID and password match.

13. A printing device as recited in claim 11, wherein the print menu module is further configured to:
check whether at least part of the user log in information corresponds to a personalized print menu; and
retrieve the personalized print menu and present the personalized print menu if at least part of the user log in information corresponds to the personalized print menu, and otherwise retrieve a default print menu and present the default print menu at the printing device.

14. A printing device as recited in claim 11, further comprising:
a local storage component configured to store personalized print menus; and
wherein the print menu module is configured to retrieve the personalized print menu from the local storage component.

15. A method comprising:
presenting print menu personalization options to a user;
receiving user-selection of one or more of the menu personalization options;
generating a personalized menu based at least in part on the received user-selection; and
associating the personalized menu with the user.

16. A method as recited in claim 15, wherein the print menu personalization options comprise a plurality of pre-defined print menus.

17. A method as recited in claim 15, wherein the print menu personalization options comprise a plurality of items that may be included in a print menu.

18. A method as recited in claim 17, wherein the receiving comprises receiving a selection of one or more of the plurality of items.

19. A method as recited in claim 17, wherein the receiving comprises receiving a selection of at least one but fewer than all of the plurality of items, and wherein the generating comprises generating the personalized menu to include only the user-selected items.

20. A method as recited in claim 17, wherein the receiving comprises receiving a selection of an ordering for one or more of the plurality of items, and wherein the generating comprises generating the personalized menu to include the user-selected ordering.

21. A method as recited in claim 15, wherein the associating comprises storing the personalized menu with a mapping to a user ID of the user.

22. A method as recited in claim 15, wherein the method is implemented in a printing device.

23. A method as recited in claim 15, wherein the method is implemented in a computing device.

24. A method as recited in claim 15, further comprising:
receiving, at a local input component, user log in information from the user;
retrieving the personalized print menu associated with the user based on the user log in information; and
presenting the personalized print menu to the user.

25. One or more computer readable media having stored thereon a plurality of instructions that, when executed by one or more controllers of a printing device, causes the one or more controllers to:
receive, from a remote device, a request to generate a customized print menu for use at the printing device;
return, to the remote device, print menu customization options for presentation to a user;
receive, from the remote device, an indication of one or more user-selected menu customization options;
generate a customized menu based at least in part on the one or more user-selected menu customization options; and
associate the customized menu with the user.

26. One or more computer readable media as recited in claim 25, wherein the plurality of instructions further cause the one or more controllers to:
receive, at a local input component, user log in information from the user;
retrieve the customized print menu associated with the user based on the user log in information; and
present the customized print menu to the user.

27. One or more computer readable media as recited in claim 25, wherein the print menu customization options comprise a plurality of items that may be included in a print menu, wherein the instructions to receive an indication of one or more user-selected menu customization options comprise instructions to receive an indication of a selection of at least one but fewer than all of the plurality of items, and wherein the instructions to generate the customized menu comprise instructions to generate the customized menu to include only the user-selected items.

28. One or more computer readable media as recited in claim 25, wherein the print menu customization options comprise a plurality of items that may be included in a print menu, wherein the instructions to receive an indication of one or more user-selected menu customization options comprise instructions to receive a selection of an ordering for one or more of the plurality of items, and wherein the instructions to generate the customized menu comprise instructions to generate the customized menu to include the user-selected ordering.

29. One or more computer readable media having stored thereon a plurality of instructions that, when executed by one or more controllers, causes the one or more controllers to:
present print menu personalization options to a user;
receive user-selection of one or more of the menu personalization options;
generate a personalized menu based at least in part on the received user-selection; and
associate the personalized menu with the user.

30. One or more computer readable media as recited in claim 29, wherein:
the print menu personalization options comprise a plurality of items that may be included in a print menu;
the instructions to receive user-selection of one or more of the menu personalization options comprise instructions to receive a selection of at least one but fewer than all of the plurality of items; and
the instructions to generate a personalized menu based at least in part on the received user-selection comprise instructions to generate the personalized menu to include only the user-selected items.

31. One or more computer readable media as recited in claim 29, wherein:
the print menu personalization options comprise a plurality of items that may be included in a print menu;
the instructions to receive user-selection of one or more of the menu personalization options comprise instructions to receive a selection of an ordering for one or more of the plurality of items; and
the instructions to generate a personalized menu based at least in part on the received user-selection comprise instructions to generate the personalized menu to include the user-selected ordering.

32. One or more computer readable media as recited in claim 29, wherein the plurality of instructions further cause the one or more controllers to:
receive, at a local input component, user log in information from the user;
retrieve the personalized print menu associated with the user based on the user log in information; and
present the personalized print menu to the user.
